(19) United States
(12) Patent Application Publication
(10) Pub. No.: US 2005/0264118 A1
(43) Pub. Date: Dec. 1, 2005

(54) Conical bearingless motor/generator

(76) Inventors: Peter E. Kascak, Eaton Township, OH (US); Ralph H. Jansen, Eaton Township, OH (US); Timothy P. Dever, Westlake, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 11/068,509

(22) Filed: Feb. 28, 2005

Related U.S. Application Data
(60) Provisional application No. 60/548,894, filed on Mar. 1, 2004.

(51) Int. Cl. H02K 7/09; H02K 5/16

(52) U.S. Cl. 310/90.5; 310/90; 384/575; 384/280

(57) ABSTRACT

A bearingless motor/generator comprises a rotatable part and a stationary part. The rotatable part is adapted to be rotated about an axis of rotation with respect to the stationary part. The stationary part has one or more windings for producing a drive field and a control field. The drive field is adapted to exert a torque on the rotatable part to transfer energy between the rotatable part and the stationary part. The control field is adapted to exert a force on the rotatable part to levitate the rotatable part. The force is adapted to be directed at an angle greater than 0° and less than 90° relative to the axis of rotation of the rotatable part.

### CROSS REFERENCE TO RELATED APPLICATIONS

This application claims the benefit of U.S. Provisional Patent Application No. 60/548,894, filed on Mar. 1, 2004.

This invention was made with government support under NCC3-916 and NCC3-924 awarded by NASA. The government has certain right in the invention.

### BACKGROUND OF INVENTION

The present invention generally relates to an electromagnetic rotary drive and more particularly, to an electromagnetic rotary drive that functions as a bearingless motor/generator.

Conventional bearingless motor/generators are commonly used in flywheels, turbines, pumps and machine tools. Bearingless motor/generators typically include an electromagnetic rotary drive having a rotating part and a stationary part. The rotary part is commonly referred to as a rotor and the stationary part is commonly referred to as a stator. The stator typically includes a drive winding for producing a drive field and a separate control winding for producing a control field. The drive field exerts a torque on the rotor that transfers energy between the rotor and the stator, and the control field exerts a force on the rotor to levitate the rotor.

Conventional bearingless motor/generators function to exert radial levitation, in the case of a radial gap machine, or axial levitation, in the case of an axial gap machine. In a radial levitation machine, additional elements are required to provide axial control of the rotor. Similarly, in an axial levitation machine, additional elements are required to provide radial control of the rotor. These additional elements increase the cost, size and weight of the machines.

A bearingless motor/generator is needed that minimizes elements required for driving and controlling the rotor and thus decreases the cost, size and weight of bearingless machines.

### SUMMARY OF INVENTION

The present invention is directed towards a bearingless motor/generator that meets the foregoing needs. The bearingless motor/generator comprises a rotatable part and a stationary part. The rotatable part is adapted to be rotated about an axis of rotation with respect to the stationary part. The stationary part has one or more windings for producing a drive field and a control field. The drive field is adapted to exert a torque on the rotatable part to transfer energy between the rotatable part and the stationary part. The control field is adapted to exert a force on the rotatable part to levitate the rotatable part. The force is adapted to be directed at an angle greater than 0° and less than 90° relative to the axis of rotation of the rotatable part. In this way, the rotatable part can be axially and radially levitated without of additional elements.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a partially cutaway perspective view of a conical bearingless motor/generator according to a first embodiment of the present invention.

FIG. 2 is a diagrammatic representational view in cross-section of the conical bearingless motor/generator illustrated in FIG. 1.

FIG. 3 is a diagrammatic representational view in cross-section of a conical bearingless motor/generator according to a second embodiment of the present invention.

FIG. 4 is a diagrammatic representational view of a sequence of control forces that could be produced by the conical bearingless motor/generator.

FIG. 5 in a diagrammatic cross-sectional view of the conical bearingless motor/generator taken along the line 5-5 in FIG. 4.

FIG. 6 is a partially cutaway perspective view of a bearingless machine having two conical bearingless motor/generators according to the present invention.

FIG. 7 is a diagrammatic representational view in cross-section of the bearingless machine illustrated in FIG. 6.

FIG. 8 is a diagrammatic representational view of a sequence of control forces that could be produced by a pair of the conical bearingless motor/generators.

FIG. 9 is a diagrammatic representational view in cross-section of a second embodiment of a bearingless machine having two conical bearingless motor/generators according to the present invention.

FIG. 10 is a diagrammatic representational view in cross-section of a third embodiment of a bearingless machine having two conical bearingless motor/generators according to the present invention.

FIG. 11 is a diagrammatic representational view in cross-section of a fourth embodiment of a bearingless machine having two conical bearingless motor/generators according to the present invention.

FIG. 12 is a diagrammatic representation in cross-section of a bearingless machine having three conical bearingless motor/generators according to the present invention.

FIG. 13 is a diagrammatic representational view in cross-section of a bearingless machine having a single conical bearingless motor/generator according to the present invention.

### DETAILED DESCRIPTION

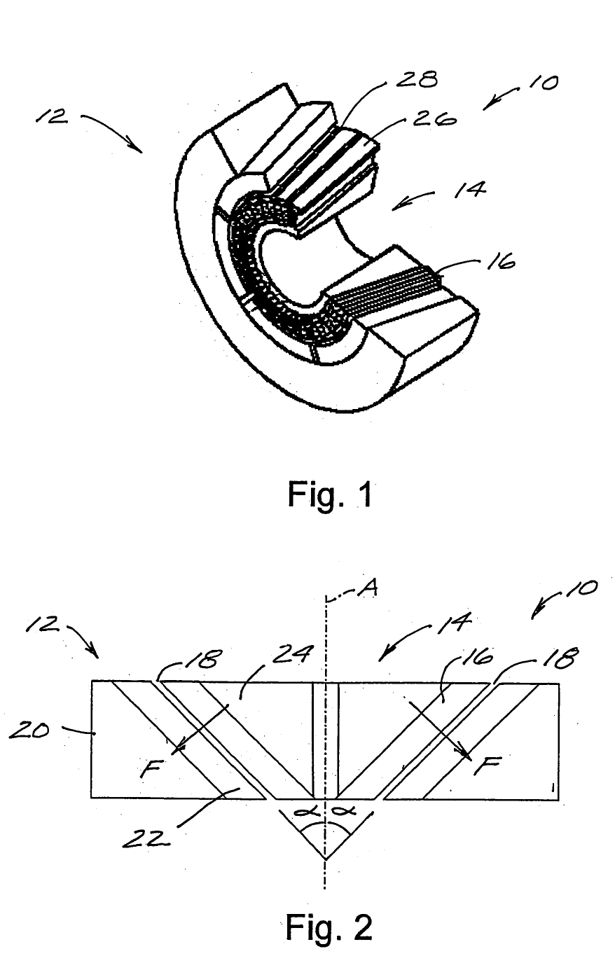

Referring now to the drawings, there is illustrated in FIGS. 1 and 2 a conical bearingless motor/generator, generally indicated at 10, according to a first embodiment of the invention. The term “motor/generator” should be clearly understood to mean that the conical bearingless motor/generator is adapted to function as either a motor or a generator. The conical bearingless motor/generator 10 comprises a rotatable part 12 and a stationary part 14. The rotatable part 12 is adapted to be rotated about an axis of rotation A (shown in FIG. 2) and with respect to the stationary part 14. The stationary part 14 has one or more windings 16 for producing both a drive field and a control field. The drive field is adapted to exert a torque on the rotatable part 12 that transfers energy between the rotatable part 12 and the stationary part 14.

As illustrated in FIG. 2, the control field is adapted to exert a force F on the rotatable part 12 to levitate the rotating part 12 with respect to the stationary part 14. The winding 16 is oriented so that the force F is directed at an angle, which is greater than 0° and less than 90° relative to the axis of rotation A of the rotatable part 12. In this way, the control field can axially and radially levitate the rotatable part 12. This levitation results in an angular air gap 18 between the rotatable part 12 and the stationary part 14. It should be appreciated that the angle of the force F may be dependent on the application of the conical bearingless motor/generator 10.

The rotatable part 12 may include a soft magnetic and/or non-magnetic structure 20, such as a back iron, and a hard magnetic structure 22, such as a permanent magnet, supported with respect to the soft magnetic and/or non-magnetic structure 20. The stationary part 14 may likewise include a soft magnetic and/or non-magnetic structure 24, such as a back iron. Teeth 26 and slots 28 (shown in FIG. 1) may be supported relative to the soft magnetic and/or non-magnetic structure 24. The teeth 26 and slots 28 support the winding 16. In addition, the teeth distribute the flux in conical bearingless motor/generator 10. Alternatively, the winding 16 may be affixed relative to the soft magnetic and/or non-magnetic structure 24 in some other suitable manner, such as with epoxy. In this case, teeth 26 and slots 28 are not required. The soft magnetic and/or non-magnetic structures 20, 24 each may include a portion that is tapered at the angle a relative to the axis of rotation A of the rotatable part 12 to hold the hard magnetic structure 22 and the winding 16 substantially parallel to one another. The angle of the force F exerted by the control field is preferably orthogonal to the angle α of the tapered portions of the rotatable part 12 and stationary part 14. The illustrated force F is a repulsive force that pushes the rotatable part 12 in a direction away from the stationary part 14. However, it should be appreciated that the force F exerted by the control field may alternatively be an attractive force to pull the rotatable part 12 in a direction towards the stationary part 14.

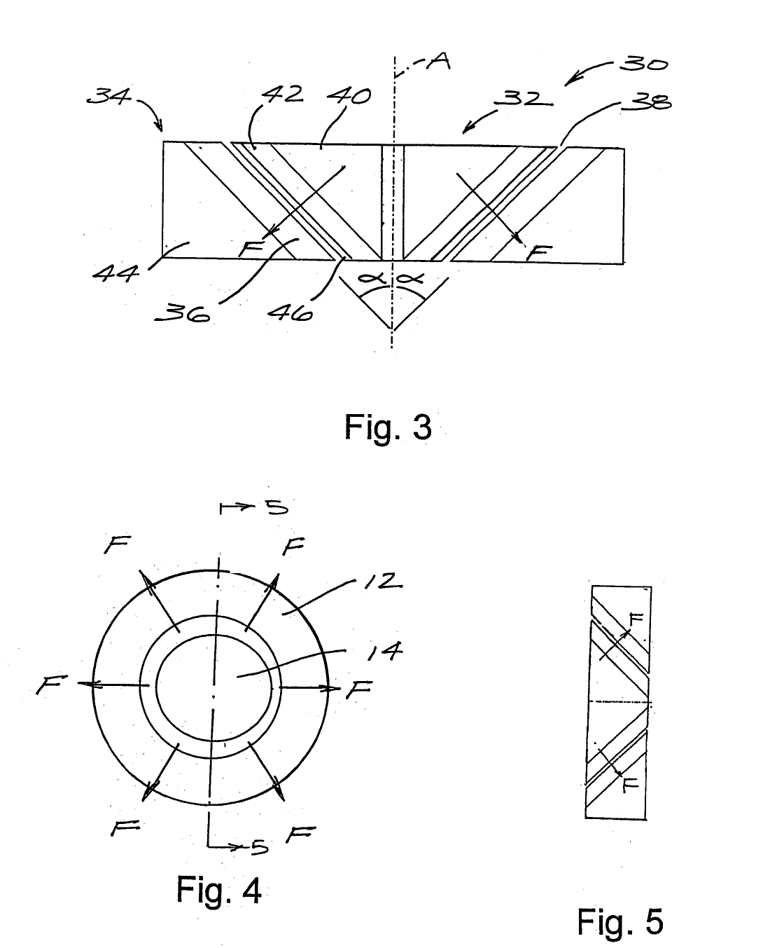

A second embodiment of the conical bearingless motor/generator 30 is illustrated in FIG. 3, wherein a rotatable part 32 is situated within a stationary part 34, converse to that the first embodiment described above. The rotatable part 32 is adapted to be rotated about an axis of rotation A and with respect to the stationary part 34. The stationary part 34 has one or more windings 36 for producing both a drive field and a control field. The drive field is adapted to exert a torque on the rotatable part 32 that transfers energy between the rotatable part 32 and the stationary part 34. The control field is adapted to exert a force F on the rotatable part 32 to levitate the rotating part 32 with respect to the stationary part 34. The winding 36 is oriented so that the force F is directed at an angle, which is greater than 0° and less than 90° relative to the axis of rotation A of the rotatable part 32. In this way, the control field can axially and radially levitate the rotatable part 32. This levitation results in an angular air gap 38 between the rotatable part 32 and the stationary part 34. It should be appreciated that the angle of the force F may be dependent on the application of the conical bearingless motor/generator 30.

The rotatable part 32 may include a soft magnetic and/or non-magnetic structure 40, such as a back iron, and a hard magnetic structure 42, such as a permanent magnet, supported with respect to the soft magnetic and/or non-magnetic structure 40. The stationary part 34 may likewise include a soft magnetic and/or non-magnetic structure 44, such as a back iron. Teeth and slots (not shown) may be supported relative to the soft magnetic and/or non-magnetic structure 44 of the stationary part 34. The teeth and slots support the winding 36. Alternatively, the winding 36 may be affixed relative to the soft magnetic and/or non-magnetic structure 44 in some other suitable manner, such as with epoxy. The soft magnetic and/or non-magnetic structures 40, 44 each may include a portion that is tapered at the angle α relative to the axis of rotation A of the rotatable part 32 to hold the hard magnetic structure 42 and the winding 36 substantially parallel to one another. The angle of the force F exerted by the control field is preferably orthogonal to the angle α of the tapered portions of the rotatable part 32 and stationary part 34. The illustrated force F is an attractive force that pulls the rotatable part 32 in a direction towards the stationary part 34. However, it should be appreciated that the force F exerted by the control field may alternatively be a repulsive force that pushes the rotatable part 32 in a direction away from the stationary part 34.

The first embodiment described above has some advantages over the second embodiment. For example, the second embodiment may require a retaining material 46, such as a carbon material, for holding the magnetic material 42 in place relative to the rotatable part 32. However, centrifugal forces exerted upon the rotatable part 12 of the first embodiment could function to hold a hard magnetic structure 22 in place relative to the rotatable part 12, without the aid of a retaining material. The elimination of the retaining material could result in a narrower air gap 18 between rotatable part 12 and the stationary part 14 of the first embodiment. A narrower air gap 18 is beneficial in conical bearingless motor/generator 10 because it will provide greater torque and greater radial force capability.

The windings 16, 36 can be controlled by any suitable control scheme. One such control scheme is described in U.S. Pat. No. 6,559,567, issued May 6, 2003, to Schöb, the description of which is incorporated herein by reference. To simplify the description, this control scheme will be discussed only with regard to the first embodiment described above. The control scheme uses two windings. One of the windings produces a drive field, which may exert a torque on the rotatable part 12 that transfers energy to the rotatable part 12. The other winding produces a control field that may exert a force on the rotatable part 12 to levitate the rotatable part 12. The windings have loops through which phase currents flow. Control devices (not shown) feed the phase currents flowing into the winding loops. The phase currents have a mutual phase shift of about 120° . The control system, as applied to a two-winding conical bearingless motor according to the present invention, produces forces transverse to the windings, such as the repulsive forces F diagrammatically represented in FIGS. 4 and 5. It should be clearly understood that the forces F could alternatively be attractive forces. By orienting the windings as described with respect to the foregoing embodiments of the invention, the force F may be directed at an angle greater than 0° and less than 90° relative to the axis of rotation of the rotatable part 12. In this way, the rotatable part 12 can be axially and radially levitated without the need of additional elements. It should be appreciated that a different number of windings with phase currents having different phase shift could produce different forces than those illustrated in FIGS. 4 and 5.

The aforementioned control scheme is described merely for illustrative purposes. It should be clearly understood that other control systems, though not described or shown, may be suitable for carrying out the present invention. Similarly, the present invention is not intended to be limited to any particular winding configuration. It should be appreciated that any suitable winding configuration may be used for carrying out the invention.

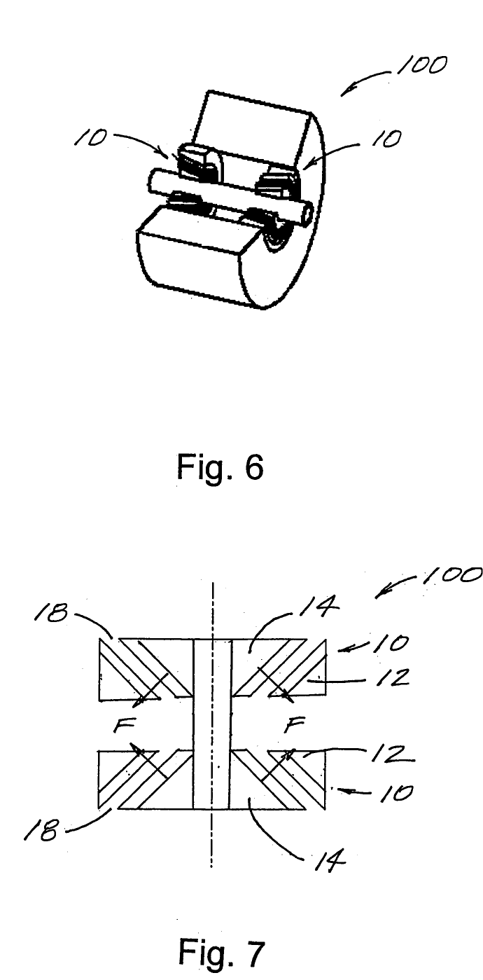

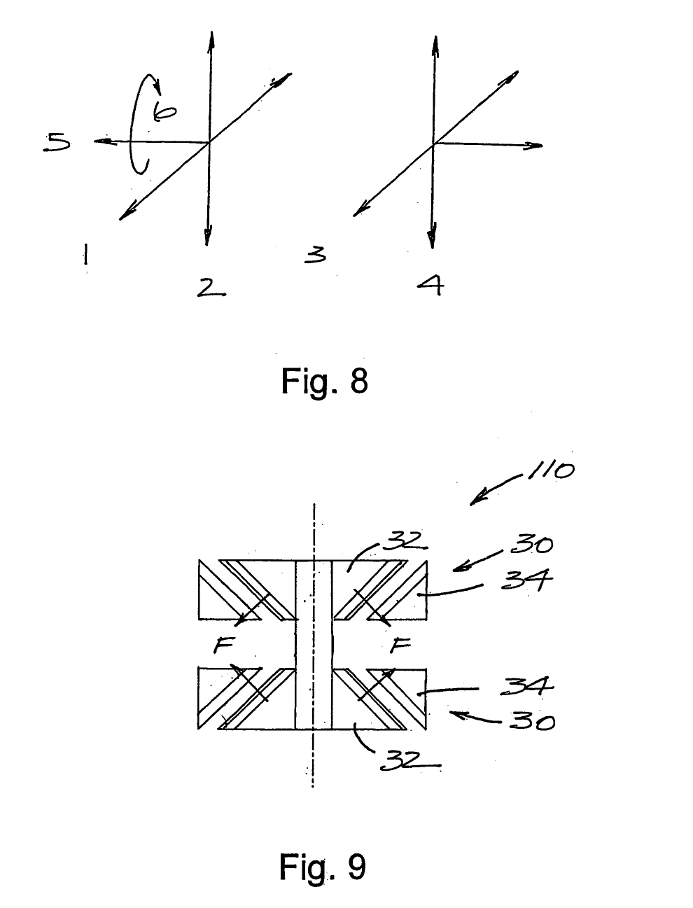

In application, one or more conical bearingless motor/generators 10 may be used to provide a magnetic suspension and drive system for rotating equipment. Two conical bearingless motor/generators 10 are used in a bearingless machine 100 provided for illustrative purposes in FIG. 6. The illustrated bearingless machine 100 is in the form of a flywheel energy storage system. However, it should be appreciated that the bearingless machine may be in other forms, such as but not limited to a turbine, a pump, a machine tool, or the like. The bearingless machine 100 may have a pair of conical bearingless motor/generators 10, similar to the conical bearingless motor/generator 10 described above and illustrated in FIGS. 1 and 2. As diagrammatically illustrated in FIG. 7, the rotatable part 12 is adapted to rotate about the stationary part 14. The conical bearingless motor/generators 10 control the rotatable part 12 along six axes, five lateral axes and one torque axis, which are diagrammatically illustrated in FIG. 8. The conical bearingless motor/generators 10 are oppositely directed. Consequently, axial components of the forces F of the two conical bearingless motor/generators 10 can cooperatively control the axial position of the rotatable parts 12 of the conical bearingless motor/generators 10 to provide axial levitation. The two conical bearingless motor/generators 10 cooperatively reduce the number of elements required to levitate the rotatable parts 12. Moreover, since the conical bearingless motor/generators 10 take up less axial length, bending mode frequencies can be increased to improve rotordynamics and ease of control of the rotatable parts 12.

Alternative embodiments of bearingless machines are illustrated in FIGS. 9-12. A second embodiment of a bearingless machine 110 is illustrated in FIG. 9. This embodiment includes a pair of conical bearingless motor/generators 30 similar to the second embodiment described above and shown in FIG. 3. In this embodiment, rotatable parts 32 are adapted to rotate within stationary parts 34. The aforementioned first embodiment of the bearingless machine 100 has some advantages over this bearingless machine 110. For example, centrifugal forces exerted upon the rotatable parts 12 of the first embodiment could hold a hard magnetic structure (not shown) in place relative to the rotatable parts 12, without the aid of a retaining material (not shown). The elimination of the retaining material could result in narrower air gaps 18 between rotatable parts 12 and the stationary parts 14 (shown in FIG. 7).

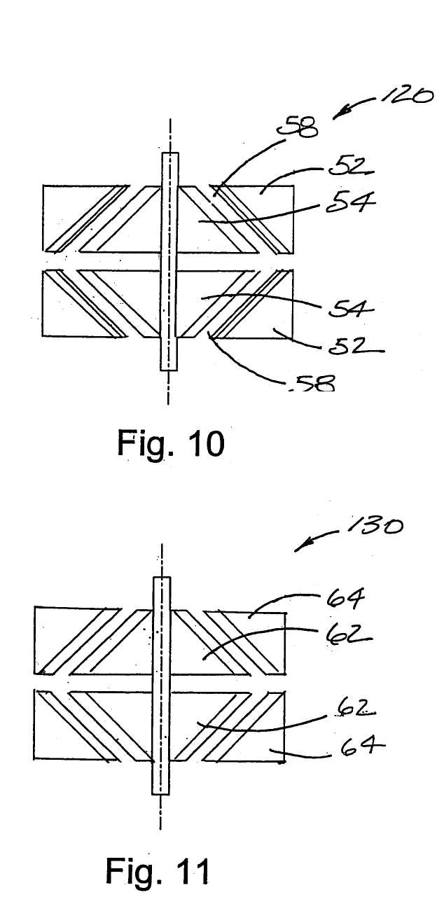

A third embodiment of a bearingless machine 120 is illustrated in FIG. 10. In accordance with this embodiment, a pair of rotatable parts 52 is supported for rotation about a pair of stationary parts 54, similar to the first embodiment of the bearingless machine 100 described above. However, the rotatable parts 52 and stationary parts 54 are tapered in opposing directions to the rotatable parts 12 and stationary parts 14 in the first embodiment of the bearingless machine 100. This bearingless machine 120 has some advantages over the aforementioned bearingless machine 110. For example, centrifugal forces exerted upon the rotatable parts 52 could hold a hard magnetic structure (not shown) in place relative to the rotatable parts 52, eliminating the need for a retaining material (not shown). The elimination of the retaining material could result in narrower air gaps 58 between rotatable parts 52 and the stationary parts 54.

In a fourth embodiment of a bearingless machine 130, which is illustrated in FIG. 11, a pair of rotatable parts 62 are supported for rotation within a pair of stationary parts 64, similar to the second embodiment of the bearingless machine 110 describe above. However, these rotatable parts 62 and stationary parts 64 are tapered in opposing directions to the rotatable parts 32 and stationary parts 34 in the second embodiment of the bearingless machine 110.

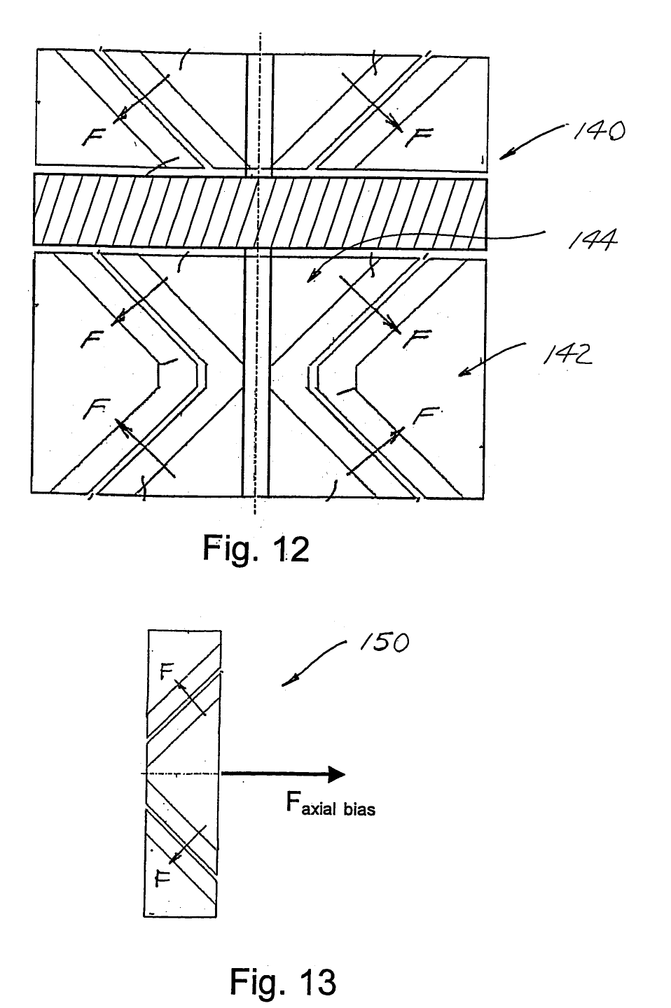

It should be appreciated that the bearingless machines described above are provided for illustrated purposes. Though two rotatable parts and two stationary parts are described as pairs, the rotatable parts can be integrally formed to form a one-piece rotor 142, as illustrated in the bearingless machine 140 in FIG. 12. Similarly, the stationary parts can be integrally formed to form a one-piece stator 144. Moreover, the bearingless machines are not limited to include a single conical bearingless motor/generator or two conical bearingless motor/generators, but instead may include any number of conical bearingless motor/generators, such as the three conical bearingless motor/generators shown.

It should be clearly understood that the rotatable parts may be supported within the stationary parts, or about the stationary parts. The rotatable parts and stationary parts may be tapered in either direction, as illustrated by comparing FIGS. 7 and 9 with FIGS. 10 and 11, respectively. The rotatable parts may or may not include a hard magnetic structure 22. Any suitable winding configuration may be used for carrying out the invention, and the invention may be practiced with any suitable control scheme. The force F exerted on the rotatable parts may be an attractive force or a repulsive force. Moreover, the force F may be directed orthogonal to any angle α, which is greater than 0° and less than 90° relative to the axis of rotation A of the rotatable parts, wherein the angle α is dependent upon the application of the bearingless machine.

It should further be understood that the conical bearingless motor/generators described and shown could function as either a conical bearingless motor or generator. For example, the bearingless machine 100 described above and illustrated in FIGS. 6 and 7 is in the form of flywheel storage system, wherein the conical bearingless motor/generator 10 is adapted to function as a motor to transfer energy from the stationary part 14 to the rotatable part 12 and further as a generator to transfer energy from the rotatable part 12 to the stationary part 14. The energy from the rotatable part 12 can be converted to electrical energy, which may be used as a power source for electrical components.

It should be appreciated that a bearingless machine 150 may have a single conical bearingless motor/generator, as illustrated in FIG. 13. The bearingless machine 150 may in the form of a pump, which is adapted to move liquid, wherein the liquid (i.e., a fluid force) provides an axial bias force F_{axial bias}. Alternatively, the bearingless machine 150 may be in the form of a turbine engine, wherein gas (i.e., another fluid force) provides an axial bias force F_{axial bias}. As yet another alternative, a single bearingless motor/generator may be used in conjunction with a mechanical bearing (not shown), wherein the mechanical bearing is adapted to provide an axial bias force F_{axial bias} (i.e., a mechanical force). Alternatively, a single conical bearingless motor/generator may be used in conjunction with a pivot for holding the rotor, wherein the axial bias force F_{axial bias} is again a mechanical force. An axial magnetic bearing (MB) may act on (e.g., via magnetic force) a single conical bearingless motor/generator. The magnetic force may be passive (e.g., through the use of permanent magnets) or active. Similarly, a radial magnetic bearing, which has some centering force, may be used with a single conical bearingless motor/generator. As yet another alternative, a single conical bearingless motor/generator may be oriented such that the weight of the rotatable part (i.e., gravitational force) holds the rotatable part in place (i.e., provides an axial bias force F_{axial bias}).

It should further be appreciated that one or more conical bearingless motor/generators may be used solely to produce an electromagnetic suspension system, without transferring energy. In this case, the conical bearingless motor/generators may have one or more windings for producing only a control field, which is adapted to exert a force on the rotatable part to levitate the rotating part with respect to the stationary part. As stated above, the winding is oriented so that the force is directed at an angle, which is greater than 0° and less than 90° relative to the axis of rotation of the rotatable part. In this way, the control field can axially and radially levitate the rotatable part.

It should be appreciated that the terms “soft magnetic”, as used throughout the description, should be understood to mean ferromagnetic. It should also be appreciated that a back iron is not required for practicing the invention. For example, the invention could be practiced as an air core motor. Moreover, teeth 26 and slots 28 are not required for practicing the invention. Further, is should be understood that the invention is not limited to be practiced as a permanent magnetic motor/generator but may be practiced as an inductive motor, a synchronous reluctance motor, a switched reluctance motor, or in other types of motor/generators that the invention may be well suited.

The principle and mode of operation of this invention have been explained and illustrated in its preferred embodiment. However, it must be understood that this invention may be practiced otherwise than as specifically explained and illustrated without departing from its spirit or scope.

1. A conical bearingless motor/generator comprising:
a rotatable part having an axis of rotation; and
a stationary part having one or more windings for producing both a drive field and a control field, the drive field being operable to exert a torque on the rotatable part that transfers energy between the rotatable part and the stationary part, the control field is operable to exert a force on the rotatable part to levitate the rotatable part, the force being directed at an angle greater than 0° and less than 90° relative to the axis of rotation of the rotatable part.

2. The conical bearingless motor/generator according to claim 1 wherein the rotatable part is adapted to be rotated within the stationary part.

3. The conical bearingless motor/generator according to claim 1 wherein the rotatable part is adapted to be rotated about the stationary part.

4. The conical bearingless motor/generator according to claim 1 wherein the rotatable part includes a soft magnetic and/or non-magnetic structure and a hard magnetic structure.

5. The conical bearingless motor/generator according to claim 4 wherein the soft magnetic and/or non-magnetic structure includes a back iron.

6. The conical bearingless motor/generator according to claim 4 wherein the hard magnetic structure is a permanent magnet.

7. The conical bearingless motor/generator according to claim 6 wherein hard magnetic structure is supported about the rotatable part with a retaining material.

8. The conical bearingless motor/generator according to claim 7 wherein the retaining material is a carbon material wrapped about the rotatable part and the hard magnetic structure to hold the hard magnetic structure in place relative to the rotatable part as the rotatable part is rotated.

9. The conical bearingless motor/generator according to claim 1 wherein the stationary part may include a soft magnetic and/or non-magnetic structure for supporting the winding.

10. The conical bearingless motor/generator according to claim 9 wherein the soft magnetic and/or non-magnetic structure includes a back iron.

11. The conical bearingless motor/generator according to claim 1 wherein the stationary part is provided with teeth and slots for supporting the winding.

12. The conical bearingless motor/generator according to claim 1 wherein the winding is affixed to the stationary part.

13. The conical bearingless motor/generator according to claim 1 wherein the winding is affixed to the stationary part with epoxy.

14. The conical bearingless motor/generator according to claim 1 wherein the force is an attractive force that pulls the rotatable part in the direction of the stationary part.

15. The conical bearingless motor/generator according to claim 1 wherein the force is a repulsive force that pushes the rotatable part in a direction away from the stationary part.

16. The conical bearingless motor/generator according to claim 1 wherein the winding is controlled by a control scheme.

17. The conical bearingless motor/generator according to claim 1 wherein rotatable part is adapted to store and discharge kinetic energy.
